(19) United States
(12) Patent Application Publication
(10) Pub. No.: US 2017/0257871 A1
(43) Pub. Date: Sep. 7, 2017

(54) TECHNIQUES FOR SELECTING A CHANNEL FOR WIRELESS COMMUNICATION BASED ON CHANNEL CLUSTERING

(71) Applicant: QUALCOMM Incorporated, San Diego, CA (US)

(72) Inventors: Liwen Yu, Santa Clara, CA (US); Damanjit Singh, San Diego, CA (US); Farhad Meshkati, San Diego, CA (US); Mostafa Khoshnevisan, San Diego, CA (US); Satashu Goel, San Diego, CA (US)

(21) Appl. No.: 15/432,717

(22) Filed: Feb. 14, 2017

Related U.S. Application Data
(60) Provisional application No. 62/302,791, filed on Mar. 2, 2016.

(51) Int. Cl. H04W 72/06; H04W 72/08

(52) U.S. Cl. CPC H04W 72/06; H04W 72/085

(57) ABSTRACT

Techniques are described for wireless communication. A method for wireless communication at a wireless device includes comparing a count of channels used by a group of neighboring cells to a maximum number of channels allowed for use by the group of neighboring cells; identifying a channel list based at least in part on the comparing, where the identified channel list is based at least in part on a list of candidate channels allowed for use by a wireless communication system or a list of the channels used by the group of neighboring cells; and selecting a channel for wireless communication from the identified channel list.

### CROSS REFERENCES

The present Application for patent claims priority to U.S. Provisional Patent Application No. 62/302,791 by YU, et al., entitled “Techniques For Selecting A Channel For Wireless Communication Based on Channel Clustering,” filed Mar. 2, 2016, assigned to the assignee hereof, and which is expressly incorporated by reference herein in its entirety.

### BACKGROUND

Field of the Disclosure

The present disclosure, for example, relates to wireless communication systems, and more particularly to techniques for selecting a channel for wireless communication based on channel clustering.

Description of Related Art

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, single-carrier frequency-division multiple access (SC-FDMA) systems, and orthogonal frequency-division multiple access (OFDMA) systems.

By way of example, a wireless multiple-access communication system may include a number of base stations or other nodes, each simultaneously supporting communication for multiple communication devices, otherwise known as user equipment (UEs). A base station may communicate with UEs on downlink channels (e.g., for transmissions from a base station to a UE) and uplink channels (e.g., for transmissions from a UE to a base station).

Base stations may communicate with UEs over a plurality of channels of one or more radio frequency spectrum bands. Neighboring base stations may communicate with UEs over different orthogonal channel to reduce the likelihood of inter-cell interference between the communications of (e.g., to or from) different base stations.

### SUMMARY

The present disclosure, for example, relates to selecting a channel for wireless communication based on channel clustering. When multiple channels are available for wireless communication over a radio frequency spectrum band, a channel may be selected for wireless communication by a wireless device (e.g., a network access device, a base station, a small cell, a closed subscriber group (CSG) host, a neutral host, or a combination thereof) based on factors such as interference reduction, throughput optimization, or UE mobility management (e.g., handover management). In some cases, it may be useful to define a maximum number of channels, of a total number of candidate channels, that are allowed for use by a group of neighboring cells (e.g., a group of cells associated with a common operator, or a common network, or a CSG, or a neutral host, or a geographic area, or a combination thereof). When the group of neighboring cells is using fewer than the maximum number of channels, a wireless device within the group of neighboring cells may select any of the candidate channels for use; however, when the group of neighboring cells is already using the maximum number of channels (or more), a wireless device within the group of neighboring cells may be limited to selecting a channel from the channels already being used by the group of neighboring cells. In some examples, this may lead to two or more wireless devices in the group using the same channel. However, inter-cell interference may be managed, for example, using techniques such as transmit power management (TPM) or inter-cell interference coordination (ICIC).

In one examples, a method for wireless communication at a wireless device is described. The method may include comparing a count of channels used by a group of neighboring cells to a maximum number of channels allowed for use by the group of neighboring cells; identifying a channel list based at least in part on the comparing, where the identified channel list is based at least in part on a list of candidate channels allowed for use by a wireless communication system or a list of the channels used by the group of neighboring cells; and selecting a channel for wireless communication from the identified channel list.

In some examples of the method, and when the count of channels used by the group of neighboring cells is less than the maximum number of channels allowed for use by the group of neighboring cells, the identified channel list may be based at least in part on the list of candidate channels allowed for use by the wireless communication system. In some examples, and when the count of channels used by the group of neighboring cells is greater than or equal to the maximum number of channels allowed for use by the group of neighboring cells, the identified channel list may be based at least in part on the list of the channels used by the group of neighboring cells.

In some examples, the method may include identifying the channels used by the group of neighboring cells based at least in part on: network listening, or automatic neighbor relation (ANR) information received from at least one UE, or a combination thereof. In some examples, the method may include identifying the maximum number of channels allowed for use by the group of neighboring cells based at least in part on: a count of groups of neighboring cells using a plurality of channels, or a count of network operators associated with cells using the plurality of channels, or a combination thereof.

In some examples, the group of neighboring cells may include at least one of: cells associated with a common operator, or cells associated with a common network, or cells associated with a CSG, or cells associated with a neutral host, or cells within a geographic area, or a combination thereof. In some examples, the method may include identifying the list of candidate channels allowed for use by the wireless communication system based at least in part on: pre-programmed information, or determined information, or information received from a network, or a combination thereof. In some examples, the method may include identifying inter-cell interference associated with at least one channel in the identified channel list, and selecting the channel for wireless communication based at least in part on the identified inter-cell interference.

In some examples, the selected channel may include a channel used by a first cell within the group of neighboring cells and a second cell within the group of neighboring cells. In some examples, the wireless device may include at least one of: a network access device, or a base station, or a small cell, or a CSG host, or a neutral host, or a combination thereof.

In one example, an apparatus for wireless communication at a wireless device is described. The apparatus may include means for comparing a count of channels used by a group of neighboring cells to a maximum number of channels allowed for use by the group of neighboring cells; means for identifying a channel list based at least in part on the comparing, where the identified channel list is based at least in part on a list of candidate channels allowed for use by a wireless communication system or a list of the channels used by the group of neighboring cells; and means for selecting a channel for wireless communication from the identified channel list.

In some examples of the apparatus, and when the count of channels used by the group of neighboring cells is less than the maximum number of channels allowed for use by the group of neighboring cells, the identified channel list may be based at least in part on the list of candidate channels allowed for use by the wireless communication system. In some examples, and when the count of channels used by the group of neighboring cells is greater than or equal to the maximum number of channels allowed for use by the group of neighboring cells, the identified channel list may be based at least in part on the list of the channels used by the group of neighboring cells.

In some examples, the apparatus may include means for identifying the channels used by the group of neighboring cells based at least in part on: network listening, or ANR information received from at least one UE, or a combination thereof. In some examples, the apparatus may include means for identifying the maximum number of channels allowed for use by the group of neighboring cells based at least in part on: a count of groups of neighboring cells using a plurality of channels, or a count of network operators associated with cells using the plurality of channels, or a combination thereof.

In some examples, the group of neighboring cells may include at least one of: cells associated with a common operator, or cells associated with a common network, or cells associated with a CSG, or cells associated with a neutral host, or cells within a geographic area, or a combination thereof. In some examples, the apparatus may include means for identifying the list of candidate channels allowed for use by the wireless communication system based at least in part on: pre-programmed information, or determined information, or information received from a network, or a combination thereof.

In some examples, the apparatus may include means for identifying inter-cell interference associated with at least one channel in the identified channel list; and means for selecting the channel for wireless communication based at least in part on the identified inter-cell interference. In some examples, the selected channel may include a channel used by a first cell within the group of neighboring cells and a second cell within the group of neighboring cells. In some examples, the wireless device may include at least one of: a network access device, or a base station, or a small cell, or a CSG host, or a neutral host, or a combination thereof.

In one example, another apparatus for wireless communication at a wireless device is described. The apparatus may include a processor, and memory in electronic communication with the processor. The processor and memory may be configured to cause the apparatus to compare a count of channels used by a group of neighboring cells to a maximum number of channels allowed for use by the group of neighboring cells; identify a channel list based at least in part on the comparing, where the identified channel list is based at least in part on a list of candidate channels allowed for use by a wireless communication system or a list of the channels used by the group of neighboring cells; and select a channel for wireless communication from the identified channel list.

In some examples of the apparatus, and when the count of channels used by the group of neighboring cells is less than the maximum number of channels allowed for use by the group of neighboring cells, the identified channel list may be based at least in part on the list of candidate channels allowed for use by the wireless communication system. In some examples, and when the count of channels used by the group of neighboring cells is greater than or equal to the maximum number of channels allowed for use by the group of neighboring cells, the identified channel list is based at least in part on the list of the channels used by the group of neighboring cells.

In some examples, the processor and memory may be configured to cause the apparatus to identify the channels used by the group of neighboring cells based at least in part on: network listening, or ANR information received from at least one UE, or a combination thereof. In some examples, the processor and memory may be configured to cause the apparatus to identify the maximum number of channels allowed for use by the group of neighboring cells based at least in part on: a count of groups of neighboring cells using a plurality of channels, or a count of network operators associated with cells using the plurality of channels, or a combination thereof.

In some examples, the group of neighboring cells may include at least one of: cells associated with a common operator, or cells associated with a common network, or cells associated with a CSG, or cells associated with a neutral host, or cells within a geographic area, or a combination thereof.

In some examples, the processor and memory may be configured to cause the apparatus to identify inter-cell interference associated with at least one channel in the identified channel list, and select the channel for wireless communication based at least in part on the identified inter-cell interference. In some examples, the selected channel may include a channel used by a first cell within the group of neighboring cells and a second cell within the group of neighboring cells.

In one example, a non-transitory computer-readable medium storing computer-executable code for wireless communication is described. The code may be executable by a processor to compare a count of channels used by a group of neighboring cells to a maximum number of channels allowed for use by the group of neighboring cells; identify a channel list based at least in part on the comparing, where the identified channel list is based at least in part on a list of candidate channels allowed for use by a wireless communication system or a list of the channels used by the group of neighboring cells; and select a channel for wireless communication from the identified channel list.

In some examples of the non-transitory computer-readable medium, and when the count of channels used by the group of neighboring cells is less than the maximum number of channels allowed for use by the group of neighboring cells, the identified channel list may be based at least in part on the list of candidate channels allowed for use by the wireless communication system. In some examples, and when the count of channels used by the group of neighboring cells is greater than or equal to the maximum number of channels allowed for use by the group of neighboring cells, the identified channel list may be based at least in part on the list of the channels used by the group of neighboring cells. In some examples, the code may be executable by the processor to identify the maximum number of channels allowed for use by the group of neighboring cells based at least in part on: a count of groups of neighboring cells using a plurality of channels, or a count of network operators associated with cells using the plurality of channels, or a combination thereof.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Additionally or alternatively, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates an example of a wireless communication system, in accordance with various aspects of the present disclosure;

FIG. 2 illustrates an example of a wireless communication system, in accordance with various aspects of the present disclosure;

FIG. 3 shows a block diagram of a wireless device for use in wireless communication, in accordance with various aspects of the present disclosure;

FIG. 4 shows a block diagram of a wireless communication manager for use in wireless communication, in accordance with various aspects of the present disclosure;

FIG. 5 shows a block diagram of a base station (e.g., a small cell, or a base station forming part or all of an eNB) for use in wireless communication, in accordance with various aspects of the present disclosure;

FIG. 6 is a flow chart illustrating an exemplary method for wireless communication at a wireless device (e.g., a network access device, a base station, a small cell, a CSG host, a neutral host, or a combination thereof), in accordance with various aspects of the present disclosure; and

FIG. 7 is a flow chart illustrating an exemplary method for wireless communication at a wireless device (e.g., a network access device, a base station, a small cell, a CSG host, a neutral host, or a combination thereof), in accordance with various aspects of the present disclosure.

### DETAILED DESCRIPTION

Techniques are described for selecting a channel for wireless communication based on channel clustering. The techniques may enable a wireless device to compare a count of channels used by a group of neighboring cells to a maximum number of channels allowed for use by the group of neighboring cells; identify a cluster of channels based at least in part on the comparing, where the identified cluster of channels is based at least in part on a list of candidate channels allowed for use by a wireless communication system or a list of the channels used by the group of neighboring cells; and select a channel for wireless communication from the identified cluster of channels.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Additionally or alternatively, features described with respect to some examples may be combined in other examples.

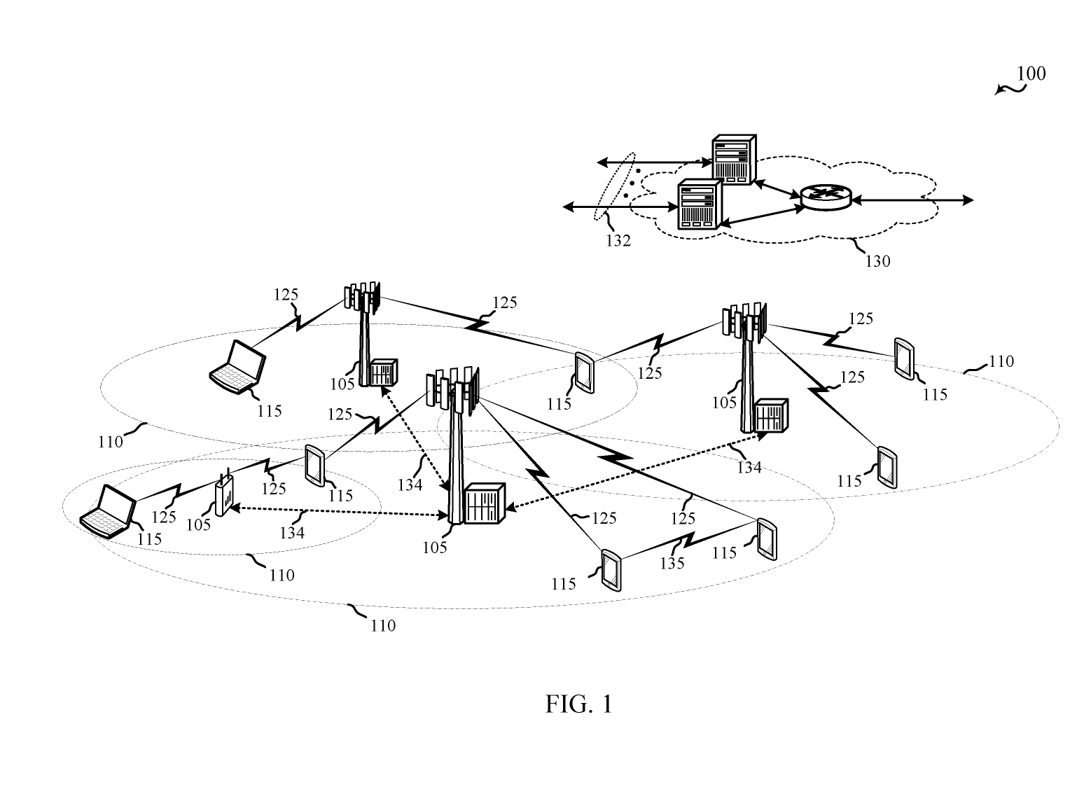

FIG. 1 illustrates an example of a wireless communication system 100, in accordance with various aspects of the present disclosure. The wireless communication system 100 may include base stations 105, UEs 115, and a core network 130. The core network 130 may provide user authentication, access authorization, tracking, Internet Protocol (IP) connectivity, and other access, routing, or mobility functions. The base stations 105 may interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X2, etc.), which may be wired or wireless communication links.

The base stations 105 may wirelessly communicate with the UEs 115 via at least one base station antenna. Each of the base station 105 sites may provide communication coverage for a respective geographic coverage area 110. In some examples, a base station 105 may be referred to as a base transceiver station, a radio base station, an access point, a radio transceiver, a NodeB, an eNodeB (eNB), a Home NodeB, a Home eNodeB, or some other suitable terminology. The geographic coverage area 110 for a base station 105 may be divided into sectors making up a portion of the coverage area (not shown). The wireless communication system 100 may include base stations 105 of different types (e.g., macro or small cell base stations). There may be overlapping geographic coverage areas 110 for different technologies.

In some examples, the wireless communication system 100 may include a Long Term Evolution (LTE) or LTE-Advanced (LTE-A) network. In LTE/LTE-A networks, the term eNB may be used to describe the base stations 105 (or entities including one or more base stations 105). The wireless communication system 100 may be a Heterogeneous LTE/LTE-A network in which different types of eNBs provide coverage for various geographical regions. For example, each eNB or base station 105 may provide communication coverage for a macro cell, a small cell, or other types of cell. The term “cell” is a 3rd Generation Partnership Project (3GPP) term that can be used to describe a base station, a carrier or component carrier associated with a base station, or a coverage area (e.g., sector, etc.) of a carrier or base station, depending on context.

A macro cell may cover a relatively large geographic area (e.g., several kilometers in radius) and may allow unrestricted access by UEs with service subscriptions with the network provider. A small cell may be a lower-powered base station, as compared with a macro cell that may operate in the same or different (e.g., dedicated, shared, etc.) radio frequency spectrums as macro cells. Small cells may include pico cells, femto cells, and micro cells according to various examples. A pico cell may cover a relatively smaller geographic area and may allow unrestricted access by UEs with service subscriptions with the network provider. A femto cell additionally or alternatively may cover a relatively small geographic area (e.g., a home) and may provide restricted access by UEs having an association with the femto cell (e.g., UEs in a CSG, UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communication system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may additionally or alternatively use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the physical (PHY) layer, the transport channels may be mapped to physical channels.

The UEs 115 may be dispersed throughout the wireless communication system 100, and each UE 115 may be stationary or mobile. A UE 115 may additionally or alternatively include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a wireless communication device, a personal computer (e.g., a laptop computer, a netbook computer, a tablet computer, etc.), a handheld device, a cellular telephone, a smart phone, a cordless phone, a wireless modem, a wireless local loop (WLL) station, a personal digital assistant (PDA), a digital video recorder (DVR), an internet appliance, a gaming console, an e-reader, etc. A UE may be able to communicate with various types of base stations and network equipment, including macro eNBs, small cell eNBs, relay base stations, and the like. A UE may also be able to communicate using different radio access technologies (RATs), such as a cellular RAT (e.g., an LTE/LTE-A RAT), a Wi-Fi RAT, or other RATs.

The communication links 125 shown in wireless communication system 100 may include downlink (DL) transmissions, from a base station 105 to a UE 115, or uplink (UL) transmissions, from a UE 115 to a base station 105. The downlink transmissions may additionally or alternatively be called forward link transmissions, while the uplink transmissions may additionally or alternatively be called reverse link transmissions.

In some examples, each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using a frequency domain duplexing (FDD) operation (e.g., using paired spectrum resources) or a time domain duplexing (TDD) operation (e.g., using unpaired spectrum resources). Frame structures for FDD operation (e.g., frame structure type 1) and TDD operation (e.g., frame structure type 2) may be defined.

In some examples of the wireless communication system 100, base stations 105 or UEs 115 may include multiple antennas for employing antenna diversity schemes to improve communication quality and reliability between base stations 105 and UEs 115. Additionally or alternatively, base stations 105 or UEs 115 may employ multiple-input, multiple-output (MIMO) techniques that may take advantage of multi-path environments to transmit multiple spatial layers carrying the same or different coded data.

The wireless communication system 100 may support operation on multiple cells or carriers, a feature which may be referred to as carrier aggregation (CA) or dual-connectivity operation. A carrier may additionally or alternatively be referred to as a component carrier (CC), a layer, a channel, etc. The terms “carrier,” “component carrier,” “cell,” and “channel” may be used interchangeably herein. A UE 115 may have multiple downlink CCs and at least one uplink CC for carrier aggregation. Carrier aggregation may be used with both FDD and TDD component carriers.

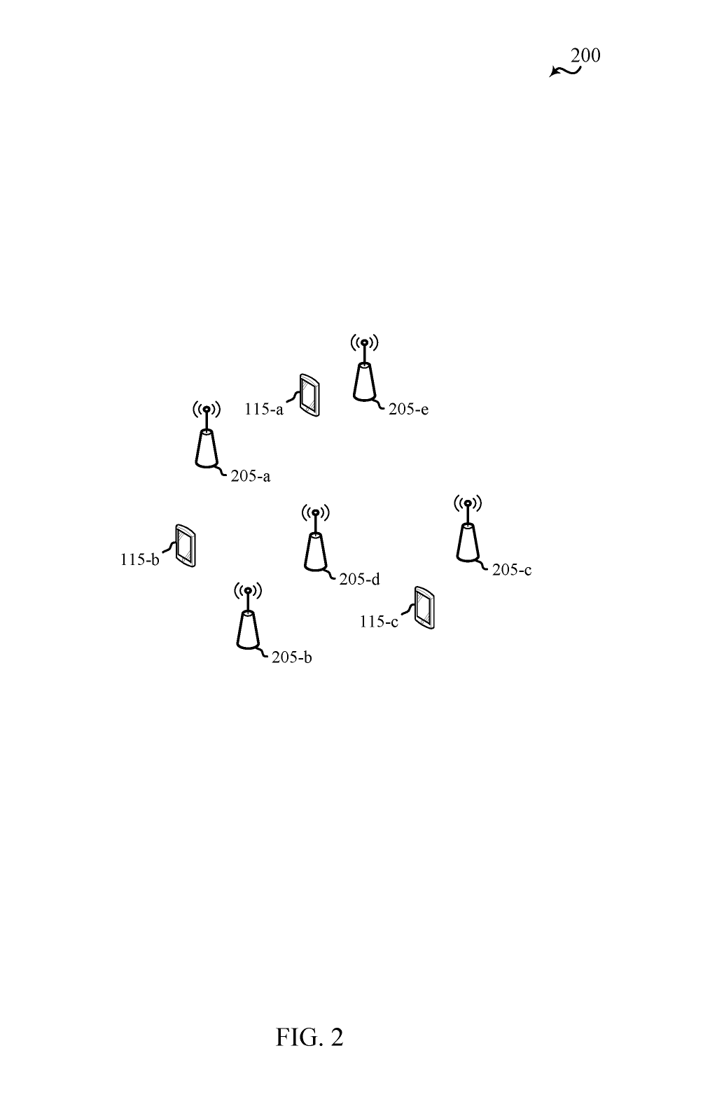

FIG. 2 illustrates an example of a wireless communication system 200, in accordance with various aspects of the present disclosure. The wireless communication system 200 may include a plurality of small cells 205 (e.g., a first small cell 205-a, a second small cell 205-b, a third small cell 205-c, a fourth small cell 205-d, and a fifth small cell 205-d) and a plurality of UEs 115 (e.g., a first UE 115-a, a second UE 115-b, and a third UE 115-c). The small cells 205 may be examples of aspects of the base stations 105 described with reference to FIG. 1, and the UEs 115 may be examples of the UEs 115 described with reference to FIG. 1. In some examples, some or all of the small cells 205 may be replaced by cells of other types, or may be replaced by CSG hosts, neutral hosts, etc.

In some examples, different small cells 205 may be associated with different operators (e.g., different mobile network operators (MNOs), different CSGs, different neutral hosts, different geographic areas, or different combinations thereof. In one example, which will be described in detail with reference to FIG. 2, the first small cell 205-a, the second small cell 205-b, and the third small cell 205-c may be associated with a common operator, but the fourth small cell 205-d and the fifth small cell 205-e may be associated with one or more other operators.

Each of the small cells 205 may communicate with one or more of the UEs 115 over one or more channels, in one or more radio frequency spectrum bands. In some examples, small cells 205 associated with different operators (or different CSGs, or different neutral hosts, or different geographic areas, or different combinations thereof) may select channels over which to communicate from a shared set of candidate channels (e.g., from a set of candidate channels in a radio frequency spectrum band available to any or all of the small cells 205).

In some examples, the shared set of candidate channels over which the small cells may communicate may include orthogonal channels, and each of the small cells 205 may communicate with one or more UEs over a different channel (or different sets of channels), to reduce the likelihood of inter-cell interference between the communications of (e.g., to or from) different small cells 205. In other examples, the shared set of candidate channels may include orthogonal channels, but two or more of the small cells 205 may be allowed to communicate over the same channel.

Allowing two or more small cells 205 to communicate over the same channel may be useful when the number or density of small cells 205 in a geographic area exceeds the number of candidate channels that the small cells 205 may use to communicate with UEs. Allowing two or more small cells 205 to communicate over the same channel may additionally or alternatively improve UE mobility between the small cells 205.

For example, allowing two or more small cells 205 to communicate over the same channel may enable a channel cluster of fewer than all candidate channels to be defined, thereby reducing the number of candidate channels that a UE 115 may need to monitor for purposes of UE mobility (e.g., for the purpose of identifying a candidate cell for handover). Allowing two or more small cells 205 to communicate over the same channel may increase the likelihood of inter-cell interference between the small cells 205; however, such inter-cell interference may be mitigated and/or canceled using cell coordination techniques, such as TPM or ICIC, particularly if the small cells 205 communicating over the same channel are associated with a common operator, a CSG, a neutral host, a geographic area, or a combination thereof.

In some examples, the small cells 205 associated with the common operator (e.g., the first small cell 205-a, the second small cell 205-b, and the third small cell 205-c) may form a group of neighboring cells. In some examples, the group of neighboring cells may be associated with a common network. In such examples, the common operator and/or the common network may enable the small cells 205 to attain mobility between the one or more cells of the group of neighboring cells. In some examples, if a neighboring cell is detected but it belongs to a different operator or network, then the detected cell may not be included in the group of neighboring cells. In such examples, the channel used by the detected cell is not counted towards a channel list.

In some examples, each of the small cells 205 in the group of neighboring cells may individually determine its membership in the group of neighboring cells. In other examples, the small cells 205 in the group of neighboring cells may collectively establish their membership in the group of neighboring cells. In other examples, another network device (e.g., the core network 130 described with reference to FIG. 1) may determine membership in the group of neighboring cells and communicate the determined membership to the small cells 205.

One or more of the small cells 205 within the group of neighboring cells may each perform a method in which the small cell 205 (e.g., the first small cell 205-a) compares a count of channels used by the group of neighboring cells to a maximum number of channels allowed for use by the group of neighboring cells; identifies a channel list based at least in part on the comparing, in which the identified channel list is based at least in part on a list of candidate channels allowed for use by a wireless communication system or a list of the channels used by the group of neighboring cells; and selects a channel for wireless communication from the identified channel list.

When the count of channels used by the group of neighboring cells is less than the maximum number of channels allowed for use by the group of neighboring cells, the identified channel list may be based at least in part on the list of candidate channels allowed for use by the wireless communication system; however, when the count of channels used by the group of neighboring cells is greater than or equal to the maximum number of channels allowed for use by the group of neighboring cells, the identified channel list may be based at least in part on the list of the channels used by the group of neighboring cells. In some examples, the identified channel list may include all of the channels in the list of candidate channels allowed for use by the wireless communication system, or all of the channels in the list of the channels used by the group of neighboring cells.

In some examples, a small cell 205 performing the above-described method may identify the list of candidate channels allowed for use by the wireless communication system based at least in part on: pre-programmed information (e.g., information stored locally at the small cell 205), determined information (e.g., information determined locally at the small cell 205), information received from a network (e.g., information received from a core network), or a combination thereof.

The small cell 205 may additionally or alternatively identify channels used by the group of neighboring cells. The channels used by the group of neighboring cells may include, for example, one or more of the candidate channels. In some examples, the channels used by the group of neighboring cells may be identified based at least in part on: network listening, ANR information received from at least one UE, or a combination thereof. The small cell 205 may additionally or alternatively identify a maximum number of channels allowed for use by the group of neighboring cells. In some examples, the maximum number of channels allowed for use by the group of neighboring cells may be identified based at least in part on: a count of groups of neighboring cells using a plurality of channels, a count of network operators associated with cells using the plurality of channels, or a combination thereof.

In some examples, a small cell 205 performing the above-described method may identify inter-cell interference associated with at least one channel in the identified channel list, and may select the channel for wireless communication based at least in part on the determined inter-cell interference. In some examples, the selected channel may include a channel used by a first small cell (e.g., the first small cell 205-a) within the group of neighboring cells and a second small cell (e.g., the second small cell 205-b) within the group of neighboring cells.

In some examples, the above-described method may be implemented by identifying or determining the parameters C, N, C_{own}, and Nₘₐₓ as follows:

C: List of candidate channels allowed for use by a wireless communication system

N: Count of channels used by the group of neighboring cells

C_{own}: List of the channels used by the group of neighboring cells

Nₘₐₓ: Maximum number of channels allowed for use by the group of neighboring cells

and applying the following algorithm:

If N<Nₘₐₓ,

Select a channel from channel list C.

Else
Select a channel from channel list C_{own}.

The method and algorithm described above enable a small cell 205 to select any candidate channel for wireless communication when the channels in a set of candidate channels are sparsely used, but tend to limit channel selection when the small cells 205 of a group of neighboring cells are already using a maximum number of channels allowed for use by the group of neighboring cells.

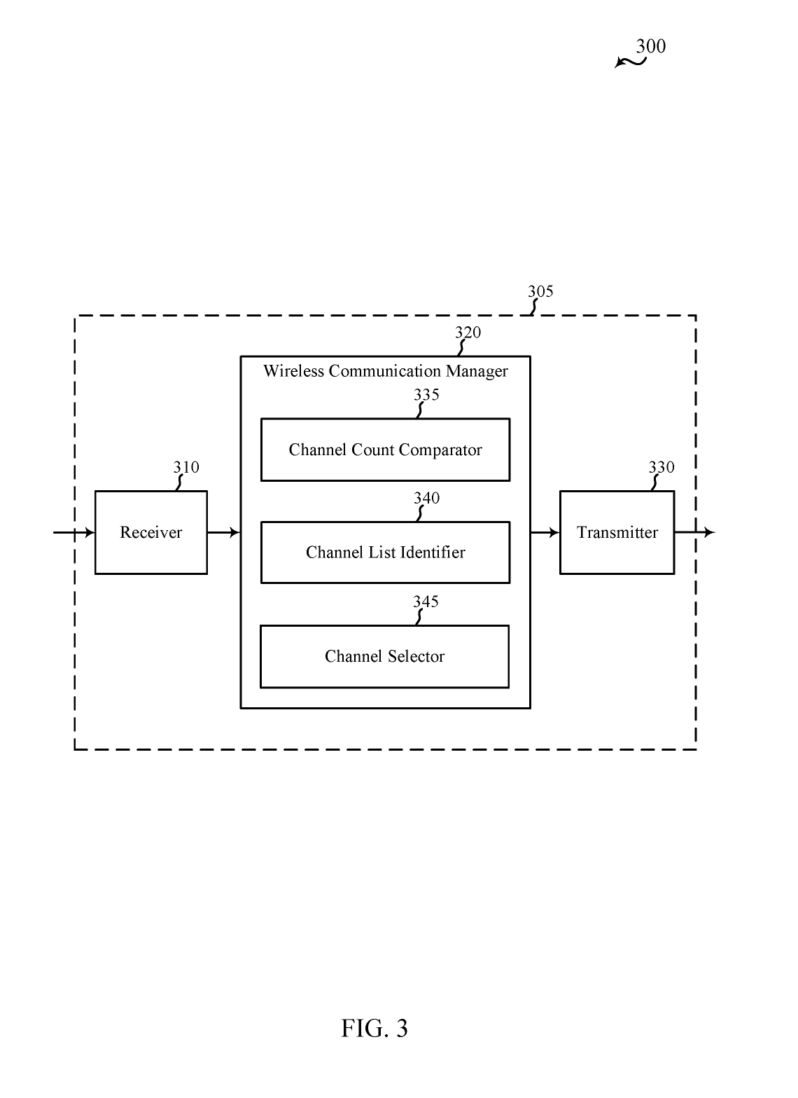

FIG. 3 shows a block diagram 300 of a wireless device 305 for use in wireless communication, in accordance with various aspects of the present disclosure. The wireless device 305 may be an example of aspects of one or more of the base stations 105 described with reference to FIG. 1, aspects of one or more of the small cells 205 described with reference to FIG. 2, aspects of a network access device, aspects of a CSG host, aspects of a neutral host, or aspects of a combination thereof. The wireless device 305 may additionally or alternatively be or include a processor. The wireless device 305 may include a receiver 310, a wireless communication manager 320, or a transmitter 330. Each of these components may be in communication with each other.

The components of the wireless device 305 may, individually or collectively, be implemented using one or more application-specific integrated circuits (ASICs) adapted to perform some or all of the applicable functions in hardware. Alternatively, the functions may be performed by one or more other processing units (or cores), on one or more integrated circuits. In other examples, others of integrated circuits may be used (e.g., Structured/Platform ASICs, Field Programmable Gate Arrays (FPGAs), a System on Chip (SoC), and/or others of Semi-Custom ICs), which may be programmed in any manner known in the art. The functions of each component may also be implemented, in whole or in part, with instructions embodied in a memory, formatted to be executed by one or more general or application-specific processors.

In some examples, the receiver 310 may include at least one radio frequency (RF) receiver, such as at least one RF receiver operable to receive transmissions over at least one radio frequency spectrum band. In some examples, one or more of the at least one radio frequency spectrum band may be used for LTE/LTE-A communication, as described, for example, with reference to FIG. 1 or 2. The receiver 310 may be used to receive various data or control signals (i.e., transmissions) over one or more communication links of a wireless communication system, such as one or more communication links of the wireless communication system 100 or 200 described with reference to FIG. 1 or 2.

In some examples, the transmitter 330 may include at least one RF transmitter, such as at least one RF transmitter operable to transmit over at least one radio frequency spectrum band. The transmitter 330 may be used to transmit various data or control signals (i.e., transmissions) over one or more communication links of a wireless communication system, such as one or more communication links of the wireless communication system 100 or 200 described with reference to FIG. 1 or 2.

In some examples, the wireless communication manager 320 may be used to manage one or more aspects of wireless communication for the wireless device 305. In some examples, part of the wireless communication manager 320 may be incorporated into or shared with the receiver 310 or the transmitter 330. In some examples, the wireless communication manager 320 may include a channel count comparator 335, a channel list identifier 340, or a channel selector 345.

The channel count comparator 335 may be used to compare a count of channels used by a group of neighboring cells to a maximum number of channels allowed for use by the group of neighboring cells. The group of neighboring cells may include a cell associated with the wireless device 305. In some examples, the group of neighboring cells may include at least one of: cells associated with a common operator, cells associated with a common network, cells associated with a CSG, cells associated with a neutral host, cells within a geographic area, or a combination thereof.

The channel list identifier 340 may be used to identify a channel list based at least in part on a comparison made by the channel count comparator 335. The channel list may be identified based at least in part on a list of candidate channels allowed for use by a wireless communication system or a list of the channels used by the group of neighboring cells. The candidate channels may include, for example, a plurality of channels within a radio frequency spectrum band. The channels used by the group of neighboring cells may include, for example, one or more of the candidate channels.

The channel selector 345 may be used to select a channel for wireless communication from the channel list identified by the channel list identifier 340. In some examples, the selected channel may include a channel used by a first cell within the group of neighboring cells and a second cell within the group of neighboring cells. In some examples, the first cell may be associated with the wireless device 305.

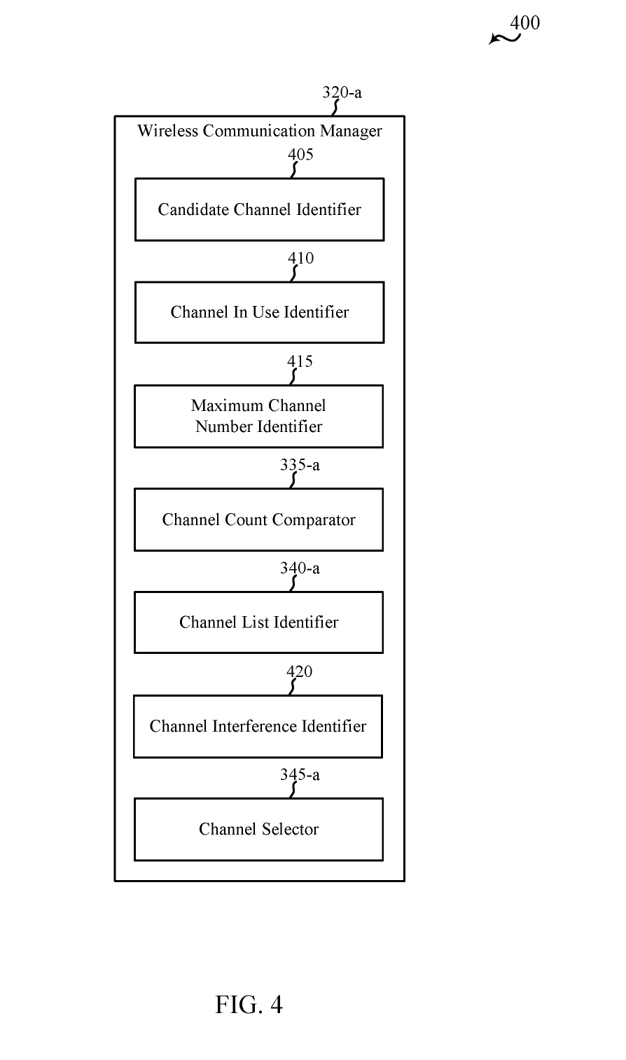

FIG. 4 shows a block diagram 400 of a wireless communication manager 320-a for use in wireless communication, in accordance with various aspects of the present disclosure. The wireless communication manager 320-a may be an example of aspects of the wireless communication manager 320 described with reference to FIG. 3.

The components of the wireless communication manager 320-a may, individually or collectively, be implemented using one or more ASICs adapted to perform some or all of the applicable functions in hardware. Alternatively, the functions may be performed by one or more other processing units (or cores), on one or more integrated circuits. In some other examples, other types of integrated circuits may be used (e.g., Structured/Platform ASICs, FPGAs, a SoC, and/or other types of Semi-Custom ICs), which may be programmed in any manner known in the art. The functions of each component may also be implemented, in whole or in part, with instructions embodied in a memory, formatted to be executed by one or more general or application-specific processors.

In some examples, the wireless communication manager 320-a may be used to manage one or more aspects of wireless communication for a wireless device, such as one of the base stations 105 described with reference to FIG. 1, one of the small cells 205 described with reference to FIG. 2, the wireless device 305 described with reference to FIG. 3, a network access device, a CSG host, a neutral host, or a combination thereof. In some examples, part of the wireless communication manager 320-a may be incorporated into or shared with a receiver or a transmitter (e.g., the receiver 310 or the transmitter 330 described with reference to FIG. 3). In some examples, the wireless communication manager 320-a may include a candidate channel identifier 405, a channel in use identifier 410, a maximum channel number identifier 415, a channel count comparator 335-a, a channel list identifier 340-a, a channel interference identifier 420, or a channel selector 345-a.

The candidate channel identifier 405 may be used to identify a list of candidate channels allowed for use by a group of neighboring cells. The candidate channels may include, for example, a plurality of channels within a radio frequency spectrum band. In some examples, the list of candidate channels may be identified based at least in part on: pre-programmed information (e.g., locally-stored information), determined information (e.g., locally-determined information), information received from a network (e.g., information received from a remote source), or a combination thereof.

The group of neighboring cells may include a cell associated with the wireless device that includes the wireless communication manager 320-a. In some examples, the group of neighboring cells may include at least one of: cells associated with a common operator, cells associated with a common network, cells associated with a CSG, cells associated with a neutral host, cells within a geographic area, or a combination thereof.

The channel in use identifier 410 may be used to identify channels used by the group of neighboring cells. The channels used by the group of neighboring cells may include, for example, one or more of the candidate channels. In some examples, the channels used by the group of neighboring cells may be identified based at least in part on: network listening, ANR information received from at least one UE, or a combination thereof.

The maximum channel number identifier 415 may be used to identify a maximum number of channels allowed for use by the group of neighboring cells. In some examples, the maximum number of channels allowed for use by the group of neighboring cells may be identified based at least in part on: a count of groups of neighboring cells using a plurality of channels, a count of network operators associated with cells using the plurality of channels, or a combination thereof.

The channel count comparator 335-a may be used to compare a count of the channels used by the group of neighboring cells to the maximum number of channels allowed for use by the group of neighboring cells.

The channel list identifier 340-a may be used to identify a channel list based at least in part on a comparison made by the channel count comparator 335-a. The channel list may be identified based at least in part on the list of candidate channels allowed for use by a wireless communication system (identified by the candidate channel identifier 405) or the list of the channels used by the group of neighboring cells (identified by the channel in use identifier 410). For example, when the count of channels used by the group of neighboring cells is less than the maximum number of channels allowed for use by the group of neighboring cells, as determined by the channel count comparator 335-a, the identified channel list may be based at least in part on the list of candidate channels allowed for use by the wireless communication system; however, when the count of channels used by the group of neighboring cells is greater than or equal to the maximum number of channels allowed for use by the group of neighboring cells, as determined by the channel count comparator 335-a, the identified channel list may be based at least in part on the list of the channels used by the group of neighboring cells. In some examples, the identified channel list may include all of the channels in the list of candidate channels allowed for use by the wireless communication system, or all of the channels in the list of the channels used by the group of neighboring cells.

The channel interference identifier 420 may be used to identify inter-cell interference associated with at least one channel in the identified channel list.

The channel selector 345-a may be used to select a channel for wireless communication from the channel list identified by the channel list identifier 340-a. In some examples, the selected channel may be selected based at least in part on the inter-cell interference identified by the channel interference identifier 420. In some examples, the selected channel may include a channel used by a first cell within the group of neighboring cells and a second cell within the group of neighboring cells. In some examples, the first cell may be associated with the wireless device that includes the wireless communication manager 320-a.

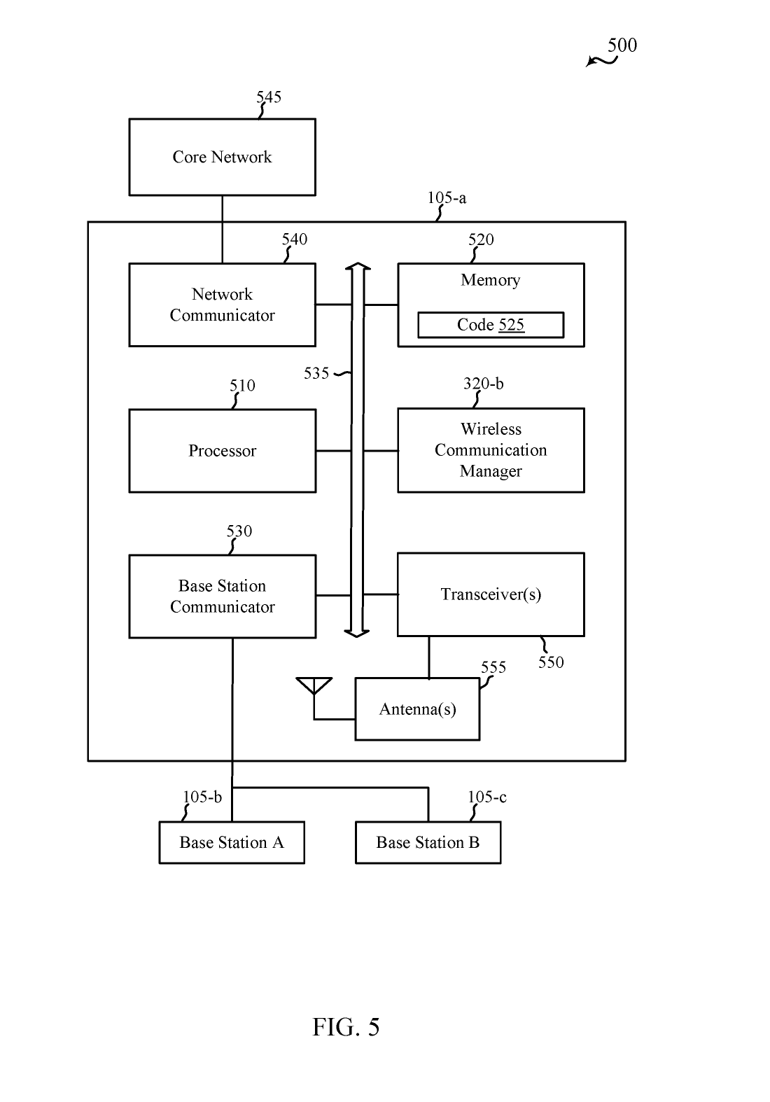

FIG. 5 shows a block diagram 500 of a base station 105-a (e.g., a small cell, or a base station forming part or all of an eNB) for use in wireless communication, in accordance with various aspects of the present disclosure. In some examples, the base station 105-a may be an example of one or more aspects of the base stations 105, small cells 205, or wireless device 305 described with reference to FIG. 1, 2, or 3. The base station 105-a may be configured to implement or facilitate at least some of the base station or small cell techniques and functions described with reference to FIG. 1, 2, 3, or 4.

The base station 105-a may include a processor 510, a memory 520, at least one transceiver (represented by transceiver(s) 550), at least one antenna (represented by antenna(s) 555), or a wireless communication manager 320-a. The base station 105-a may additionally or alternatively include one or more of a base station communicator 530 or a network communicator 540. Each of these components may be in communication with each other, directly or indirectly, over one or more buses 535.

The memory 520 may include random access memory (RAM) or read-only memory (ROM). The memory 520 may store computer-readable, computer-executable code 525 containing instructions that are configured to, when executed, cause the processor 510 to perform various functions described herein related to wireless communication, including, for example, selecting a channel for wireless communication from an identified channel list. Alternatively, the computer-executable code 525 may not be directly executable by the processor 510 but be configured to cause the base station 105-a (e.g., when compiled and executed) to perform various of the functions described herein.

The processor 510 may include an intelligent hardware device, e.g., a central processing unit (CPU), a microcontroller, an ASIC, etc. The processor 510 may process information received through the transceiver(s) 550, the base station communicator 530, or the network communicator 540. The processor 510 may additionally or alternatively process information to be sent to the transceiver(s) 550 for transmission through the antenna(s) 555, to the base station communicator 530 for transmission to one or more other base stations (e.g., base station 105-b and/or base station 105-c), or to the network communicator 540 for transmission to a core network 545, which may be an example of one or more aspects of the core network 130 described with reference to FIG. 1. The processor 510 may handle, alone or in connection with the wireless communication manager 320-b, various aspects of communicating over (or managing communications over) one or more radio frequency spectrum bands.

The transceiver(s) 550 may include a modem configured to modulate packets and provide the modulated packets to the antenna(s) 555 for transmission, and to demodulate packets received from the antenna(s) 555. The transceiver(s) 550 may, in some examples, be implemented as one or more transmitters and one or more separate receivers. The transceiver(s) 550 may support communications in one or more radio frequency spectrum bands. The transceiver(s) 550 may be configured to communicate bi-directionally, via the antenna(s) 555, with one or more UEs or other wireless devices, such as one or more of the UEs 115 described with reference to FIG. 1 or 2. The base station 105-a may, for example, include multiple antennas 555 (e.g., an antenna array). The base station 105-a may communicate with the core network 545 through the network communicator 540. The base station 105-a may additionally or alternatively communicate with other base stations, such as the base station 105-b and/or the base station 105-c, using the base station communicator 530.

The wireless communication manager 320-b may be configured to perform or control some or all of the techniques or functions described with reference to FIG. 1, 2, 3, or 4 related to wireless communication over a radio frequency spectrum band. The wireless communication manager 320-b, or portions of it, may include a processor, or some or all of the functions of the wireless communication manager 320-b may be performed by the processor 510 or in connection with the processor 510. In some examples, the wireless communication manager 320-b may be an example of the wireless communication manager 320 described with reference to FIG. 3 or 4.

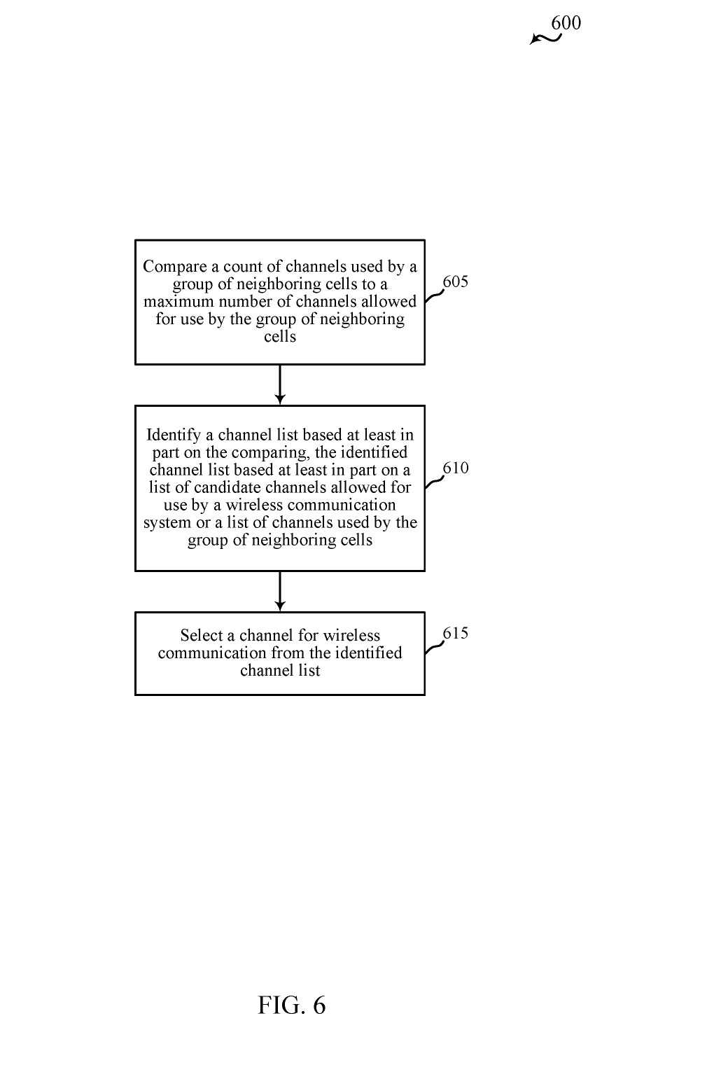

FIG. 6 is a flow chart illustrating an exemplary method 600 for wireless communication at a wireless device (e.g., a network access device, a base station, a small cell, a CSG host, a neutral host, or a combination thereof), in accordance with various aspects of the present disclosure. For clarity, the method 600 is described below with reference to aspects of one or more of the base stations 105, small cells 205, wireless devices 305, or wireless communication managers 320 described with reference to FIG. 1, 2, 3, 4, or 5. In some examples, a base station, wireless device, or wireless communication manager may execute one or more sets of codes to control the functional elements of the base station, wireless device, or wireless communication manager to perform the functions described below. Additionally or alternatively, the base station, wireless device, or wireless communication manager may perform one or more of the functions described below using special-purpose hardware.

At block 605, the method 600 may include comparing a count of channels used by a group of neighboring cells to a maximum number of channels allowed for use by the group of neighboring cells. The group of neighboring cells may include a cell associated with the wireless device performing the method 600; and in some examples, wireless devices associated with each of the cells in the group of neighboring cells may, independently, perform the method 600. In some examples, the group of neighboring cells may include at least one of: cells associated with a common operator, cells associated with a common network, cells associated with a CSG, cells associated with a neutral host, cells within a geographic area, or a combination thereof. The operations at block 605 may be performed using the wireless communication manager 320 described with reference to FIG. 3, 4, or 5, or the channel count comparator 335 described with reference to FIG. 3 or 4.

At block 610, the method 600 may include identifying a channel list based at least in part on the comparing. The channel list may be identified based at least in part on a list of candidate channels allowed for use by a wireless communication system or a list of the channels used by the group of neighboring cells. The candidate channels may include, for example, a plurality of channels within a radio frequency spectrum band. The channels used by the group of neighboring cells may include, for example, one or more of the candidate channels. The operations at block 610 may be performed using the wireless communication manager 320 described with reference to FIG. 3, 4, or 5, or the channel list identifier 340 described with reference to FIG. 3 or 4.

At block 615, the method 600 may include selecting a channel for wireless communication from the identified channel list. In some examples, the selected channel may include a channel used by a first cell within the group of neighboring cells and a second cell within the group of neighboring cells. In some examples, the first cell may be associated with the wireless device performing the method 600. The operations at block 615 may be performed using the wireless communication manager 320 described with reference to FIG. 3, 4, or 5, or the channel selector 345 described with reference to FIG. 3 or 4.

Thus, the method 600 may provide for wireless communication. It should be noted that the method 600 is just one example and that the operations of the method 600 may be rearranged or otherwise modified such that other examples are possible.

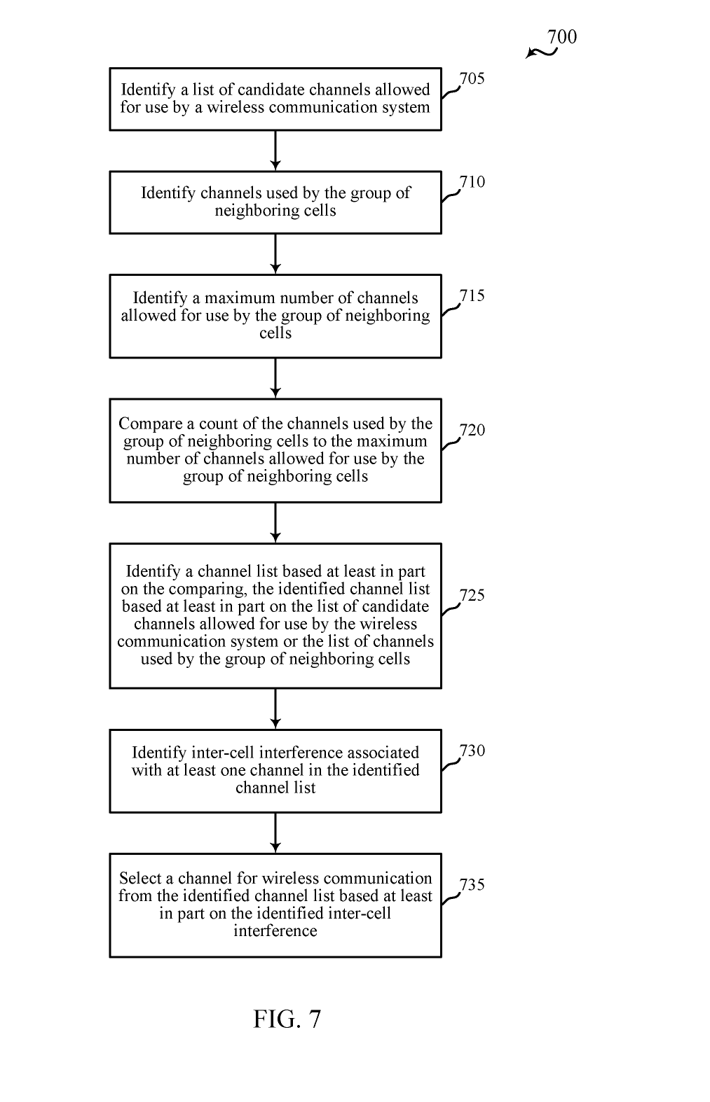

FIG. 7 is a flow chart illustrating an exemplary method 700 for wireless communication at a wireless device (e.g., a network access device, a base station, a small cell, a CSG host, a neutral host, or a combination thereof), in accordance with various aspects of the present disclosure. For clarity, the method 700 is described below with reference to aspects of one or more of the base stations 105, small cells 205, wireless devices 305, or wireless communication managers 320 described with reference to FIG. 1, 2, 3, 4, or 5. In some examples, a base station, wireless device, or wireless communication manager may execute one or more sets of codes to control the functional elements of the base station, wireless device, or wireless communication manager to perform the functions described below. Additionally or alternatively, the base station, wireless device, or wireless communication manager may perform one or more of the functions described below using special-purpose hardware.

At block 705, the method 700 may include identifying a list of candidate channels allowed for use by a group of neighboring cells. The candidate channels may include, for example, a plurality of channels within a radio frequency spectrum band. In some examples, the list of candidate channels may be identified based at least in part on: pre-programmed information (e.g., locally-stored information), determined information (e.g., locally-determined information), information received from a network (e.g., information received from a remote source), or a combination thereof. The group of neighboring cells may include a cell associated with the wireless device performing the method 600; and in some examples, wireless devices associated with each of the cells in the group of neighboring cells may, independently, perform the method 600. In some examples, the group of neighboring cells may include at least one of: cells associated with a common operator, cells associated with a common network, cells associated with a CSG, cells associated with a neutral host, cells within a geographic area, or a combination thereof. The operations at block 705 may be performed using the wireless communication manager 320 described with reference to FIG. 3, 4, or 5, or the candidate channel identifier 405 described with reference to FIG. 4.

At block 710, the method 700 may include identifying channels used by the group of neighboring cells. The channels used by the group of neighboring cells may include, for example, one or more of the candidate channels. In some examples, the channels used by the group of neighboring cells may be identified based at least in part on: network listening, ANR information received from at least one UE, or a combination thereof. The operations at block 710 may be performed using the wireless communication manager 320 described with reference to FIG. 3, 4, or 5, or the channel in use identifier 410 described with reference to FIG. 4.

At block 715, the method 700 may include identifying a maximum number of channels allowed for use by the group of neighboring cells. In some examples, the maximum number of channels allowed for use by the group of neighboring cells may be identified based at least in part on: a count of groups of neighboring cells using a plurality of channels, a count of network operators associated with cells using the plurality of channels, or a combination thereof. The operations at block 715 may be performed using the wireless communication manager 320 described with reference to FIG. 3, 4, or 5, or the maximum channel number identifier 415 described with reference to FIG. 4.

At block 720, the method 700 may include comparing a count of the channels used by the group of neighboring cells to the maximum number of channels allowed for use by the group of neighboring cells. The operations at block 720 may be performed using the wireless communication manager 320 described with reference to FIG. 3, 4, or 5, or the channel count comparator 335 described with reference to FIG. 3 or 4.

At block 725, the method 700 may include identifying a channel list based at least in part on the comparing. The channel list may be identified based at least in part on the list of candidate channels allowed for use by a wireless communication system (identified at block 705) or the list of the channels used by the group of neighboring cells (identified at block 710). For example, when the count of channels used by the group of neighboring cells is less than the maximum number of channels allowed for use by the group of neighboring cells, as determined at block 720, the identified channel list may be based at least in part on the list of candidate channels allowed for use by the wireless communication system; however, when the count of channels used by the group of neighboring cells is greater than or equal to the maximum number of channels allowed for use by the group of neighboring cells, as determined at block 720, the identified channel list may be based at least in part on the list of the channels used by the group of neighboring cells. In some examples, the identified channel list may include all of the channels in the list of candidate channels allowed for use by the wireless communication system, or all of the channels in the list of the channels used by the group of neighboring cells. The operations at block 725 may be performed using the wireless communication manager 320 described with reference to FIG. 3, 4, or 5, or the channel list identifier 340 described with reference to FIG. 3 or 4.

At block 730, the method 700 may include identifying inter-cell interference associated with at least one channel in the identified channel list. The operations at block 730 may be performed using the wireless communication manager 320 described with reference to FIG. 3, 4, or 5, or the channel interference identifier 420 described with reference to FIG. 4.

At block 735, the method 700 may include selecting a channel for wireless communication from the identified channel list. In some examples, the selected channel may be selected based at least in part on the inter-cell interference identified at block 730. In some examples, the selected channel may include a channel used by a first cell within the group of neighboring cells and a second cell within the group of neighboring cells. In some examples, the first cell may be associated with the wireless device performing the method 700. The operations at block 715 may be performed using the wireless communication manager 320 described with reference to FIG. 3, 4, or 5, or the channel selector 345 described with reference to FIG. 3 or 4.

Thus, the method 700 may provide for wireless communication. It should be noted that the method 700 is just one example and that the operations of the method 700 may be rearranged or otherwise modified such that other examples are possible.

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-A are new releases of UMTS that use E-UTRA. UTRA, E-UTRA, UMTS, LTE, LTE-A, and GSM are described in documents from an organization named 3GPP. CDMA2000 and UMB are described in documents from an organization named “3GPP2”. The techniques described herein may be used for the systems and radio technologies mentioned above as well as other systems and radio technologies, including cellular (e.g., LTE) communications over a shared radio frequency spectrum band. The description above, however, describes an LTE/LTE-A system for purposes of example, and LTE terminology is used in much of the description above, although the techniques are applicable beyond LTE/LTE-A applications.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such example.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A A-A-A, A-A-B, A-A-C, A-B-B, A-C-C, B-B, B-B-B, B-B-C, C-C, and C-C-C or any other ordering of A, B, and C).

As used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication at a wireless device, comprising:
comparing a count of channels used by a group of neighboring cells to a maximum number of channels allowed for use by the group of neighboring cells;
identifying a channel list based at least in part on the comparing, the identified channel list based at least in part on a list of candidate channels allowed for use by a wireless communication system or a list of the channels used by the group of neighboring cells; and
selecting a channel for wireless communication from the identified channel list.

2. The method of claim 1, wherein, when the count of channels used by the group of neighboring cells is less than the maximum number of channels allowed for use by the group of neighboring cells, the identified channel list is based at least in part on the list of candidate channels allowed for use by the wireless communication system.

3. The method of claim 1, wherein, when the count of channels used by the group of neighboring cells is greater than or equal to the maximum number of channels allowed for use by the group of neighboring cells, the identified channel list is based at least in part on the list of the channels used by the group of neighboring cells.

4. The method of claim 1, further comprising:
identifying the channels used by the group of neighboring cells based at least in part on: network listening, or automatic neighbor relation (ANR) information received from at least one user equipment (UE), or a combination thereof.

5. The method of claim 1, further comprising:
identifying the maximum number of channels allowed for use by the group of neighboring cells based at least in part on: a count of groups of neighboring cells using a plurality of channels, or a count of network operators associated with cells using the plurality of channels, or a combination thereof.

6. The method of claim 1, wherein the group of neighboring cells comprises at least one of: cells associated with a common operator, or cells associated with a common network, or cells associated with a closed subscriber group (CSG), or cells associated with a neutral host, or cells within a geographic area, or a combination thereof.

7. The method of claim 1, further comprising:
identifying the list of candidate channels allowed for use by the wireless communication system based at least in part on: pre-programmed information, or determined information, or information received from a network, or a combination thereof.

8. The method of claim 1, further comprising:
identifying inter-cell interference associated with at least one channel in the identified channel list; and
selecting the channel for wireless communication based at least in part on the identified inter-cell interference.

9. The method of claim 1, wherein the selected channel comprises a channel used by a first cell within the group of neighboring cells and a second cell within the group of neighboring cells.

10. The method of claim 1, wherein the wireless device comprises at least one of: a network access device, or a base station, or a small cell, or a CSG host, or a neutral host, or a combination thereof.

11. An apparatus for wireless communication at a wireless device, comprising:
means for comparing a count of channels used by a group of neighboring cells to a maximum number of channels allowed for use by the group of neighboring cells;
means for identifying a channel list based at least in part on the comparing, the identified channel list based at least in part on a list of candidate channels allowed for use by a wireless communication system or a list of the channels used by the group of neighboring cells; and
means for selecting a channel for wireless communication from the identified channel list.

12. The apparatus of claim 11, wherein, when the count of channels used by the group of neighboring cells is less than the maximum number of channels allowed for use by the group of neighboring cells, the identified channel list is based at least in part on the list of candidate channels allowed for use by the wireless communication system.

13. The apparatus of claim 11, wherein, when the count of channels used by the group of neighboring cells is greater than or equal to the maximum number of channels allowed for use by the group of neighboring cells, the identified channel list is based at least in part on the list of the channels used by the group of neighboring cells.

14. The apparatus of claim 11, further comprising:
means for identifying the channels used by the group of neighboring cells based at least in part on: network listening, or automatic neighbor relation (ANR) information received from at least one user equipment (UE), or a combination thereof.

15. The apparatus of claim 11, further comprising:
means for identifying the maximum number of channels allowed for use by the group of neighboring cells based at least in part on: a count of groups of neighboring cells using a plurality of channels, or a count of network operators associated with cells using the plurality of channels, or a combination thereof.

16. The apparatus of claim 11, wherein the group of neighboring cells comprises at least one of: cells associated with a common operator, or cells associated with a common network, or cells associated with a closed subscriber group (CSG), or cells associated with a neutral host, or cells within a geographic area, or a combination thereof.

17. An apparatus for wireless communication at a wireless device, comprising:
a processor; and
memory in electronic communication with the processor;
the processor and memory configured to cause the apparatus to:
compare a count of channels used by a group of neighboring cells to a maximum number of channels allowed for use by the group of neighboring cells;
identify a channel list based at least in part on the comparing, the identified channel list based at least in part on a list of candidate channels allowed for use by a wireless communication system or a list of the channels used by the group of neighboring cells; and
select a channel for wireless communication from the identified channel list.

18. The apparatus of claim 17, wherein, when the count of channels used by the group of neighboring cells is less than the maximum number of channels allowed for use by the group of neighboring cells, the identified channel list is based at least in part on the list of candidate channels allowed for use by the wireless communication system.

19. The apparatus of claim 17, wherein, when the count of channels used by the group of neighboring cells is greater than or equal to the maximum number of channels allowed for use by the group of neighboring cells, the identified channel list is based at least in part on the list of the channels used by the group of neighboring cells.

20. The apparatus of claim 17, wherein the processor and memory are configured to cause the apparatus to:
identify the channels used by the group of neighboring cells based at least in part on: network listening, or automatic neighbor relation (ANR) information received from at least one user equipment (UE), or a combination thereof.

21. The apparatus of claim 17, wherein the processor and memory are configured to cause the apparatus to:
identify the maximum number of channels allowed for use by the group of neighboring cells based at least in part on: a count of groups of neighboring cells using a plurality of channels, or a count of network operators associated with cells using the plurality of channels, or a combination thereof.

22. The apparatus of claim 17, wherein the group of neighboring cells comprises at least one of: cells associated with a common operator, or cells associated with a common network, or cells associated with a closed subscriber group (CSG), or cells associated with a neutral host, or cells within a geographic area, or a combination thereof.

23. The apparatus of claim 17, wherein the processor and memory are configured to cause the apparatus to:
identify the list of candidate channels allowed for use by the wireless communication system based at least in part on: pre-programmed information, or determined information, or information received from a network, or a combination thereof.

24. The apparatus of claim 17, wherein the processor and memory are configured to cause the apparatus to:
identify inter-cell interference associated with at least one channel in the identified channel list; and
select the channel for wireless communication based at least in part on the identified inter-cell interference.

25. The apparatus of claim 17, wherein the selected channel comprises a channel used by a first cell within the group of neighboring cells and a second cell within the group of neighboring cells.

26. The apparatus of claim 17, wherein the wireless device comprises at least one of: a network access device, or a base station, or a small cell, or a CSG host, or a neutral host, or a combination thereof.

27. A non-transitory computer-readable medium storing computer-executable code for wireless communication, the code executable by a processor to:
compare a count of channels used by a group of neighboring cells to a maximum number of channels allowed for use by the group of neighboring cells;
identify a channel list based at least in part on the comparing, the identified channel list based at least in part on a list of candidate channels allowed for use by a wireless communication system or a list of the channels used by the group of neighboring cells; and
select a channel for wireless communication from the identified channel list.

28. The apparatus of claim 27, wherein, when the count of channels used by the group of neighboring cells is less than the maximum number of channels allowed for use by the group of neighboring cells, the identified channel list is based at least in part on the list of candidate channels allowed for use by the wireless communication system.

29. The apparatus of claim 27, wherein, when the count of channels used by the group of neighboring cells is greater than or equal to the maximum number of channels allowed for use by the group of neighboring cells, the identified channel list is based at least in part on the list of the channels used by the group of neighboring cells.

30. The apparatus of claim 27, wherein the code is executable by the processor to:
identify the maximum number of channels allowed for use by the group of neighboring cells based at least in part on: a count of groups of neighboring cells using a plurality of channels, or a count of network operators associated with cells using the plurality of channels, or a combination thereof.
